(19) United States
(12) Patent Application Publication
(10) Pub. No.: US 2020/0058238 A1
(43) Pub. Date: Feb. 20, 2020

(54) VISUAL DISPLAY DEVICE

(71) Applicant: TAIT TOWERS MANUFACTURING, LLC, Lititz, PA (US)

(72) Inventor: Adam DAVIS, Leola, PA (US)

(21) Appl. No.: 16/662,840

(22) Filed: Oct. 24, 2019

Related U.S. Application Data
(63) Continuation-in-part of application No. 15/698,425, filed on Sep. 7, 2017.
Application No. 15/698,425 is a reissue of application No. 13/767,428, filed on Feb. 14, 2013, now Pat. No. 9,609,776.

(30) Foreign Application Priority Data
Dec. 18, 2012 (BE) 2012/0846
Dec. 18, 2012 (EP) 1355036-0001
Dec. 18, 2012 (EP) 1355036-0002

(51) Int. Cl. G09F 9/37; G09F 11/02; F16M 11/08; F16M 11/04

(52) U.S. Cl. CPC G09F 9/37; G09F 11/025; F21Y 2105/00; F16M 11/041; F16M 11/08

(57) ABSTRACT

A visual display device includes a plurality of display panels forming a display area. Each of the display panels is securable to a common support device and independently movable relative to a nonmovable axis associated with the common support device. The common support device is nonmovably positioned within the display area. The display panels are positionable in a first position, including a first display panel movable relative to a nonmovable first axis and a second display panel movable relative to a nonmovable second axis. The first axis and the second axis are nonparallel to each other. The first display panel and the second display panel are capable of simultaneous movement. The common support device is supported in a suspended disposition from a ceiling.

### FIELD OF THE DISCLOSURE

The present disclosure relates to visual display devices and structures for supporting the same. More specifically, the present disclosure relates to visual display devices having moving display panels relative to the supporting structures and a method for making the same.

### BACKGROUND OF THE DISCLOSURE

Display systems, such as conventional video display systems used in venues for public performance utilize display panels that are fixedly attached to support structure. Typically, these display systems are limited to two dimensions, and are immobile during the performance.

Motion has been incorporated into art forms such as man-made water fountains, providing a dynamic and pleasing authentic three dimensional visual experience. However, to date, display systems, such as those composed of flat screens have not incorporated such authentic three dimensional movement.

Therefore, there is an unmet need to provide visual displays incorporating relative movement between adjacent display panels as an integral part of a public performance. Such relative movement between adjacent panels either alone or in combination with specially configured lighting effects, can provide an intriguing, highly entertaining visual experience.

### SUMMARY OF THE DISCLOSURE

One aspect of the disclosure refers to a visual display device including a plurality of display panels forming a display area, each of the display panels is securable to a common support device and independently movable relative to a nonmovable axis associated with the common support device. The visual display device further provides the common support device nonmovably positioned within the display area. The visual display device further provides the display panels positionable in a first position. The visual display device further provides including a first display panel movable relative to a nonmovable first axis and a second display panel movable relative to a nonmovable second axis, the first axis and the second axis being nonparallel to each other. The visual display device further provides the first display panel and the second display panel are capable of simultaneous movement. The common support device is supported in a suspended disposition from a ceiling via either an arrangement in which the common support device is connected to a direct suspended support member that is connected to the ceiling or an arrangement in which the common support device is connected to a suspension framework and the suspension framework is connected to the ceiling via a direct suspended support member that is connected to the ceiling.

Another aspect of the disclosure refers to an assembly for providing select visual displays, the assembly including a suspension framework and a plurality of fixed view panels. The assembly further provides each fixed view panel being supportable by the suspension framework at a predetermined stand-off spacing from a reference surface. The assembly further provides a plurality of variable tilt panels, each variable tilt panel being supportable by the suspension framework at a predetermined stand-off spacing from the reference surface. The assembly further provides a common support device, the common support device being supported within a display area by the suspension framework. The assembly further provides a first one of the variable tilt panels being independently movable relative to a first nonmovable axis associated with the common support device. The assembly further provides a second one of the variable tilt panels being independently movable relative to a second nonmovable axis associated with the common support device, and the first nonmovable axis and the second nonmovable axis being nonparallel to each other. The first one of the variable tilt panels and the second one of the variable tilt panels are capable of simultaneous movement.

Another aspect of the disclosure refers to a visual display device including a first display grouping including at least two display panels forming a first display area. The visual display device further providing each of the display panels of the first display grouping is securable to a first common support device. The visual display device further providing at least one surface of the first common support device continuously forming a portion of the first display area. The visual display device further providing a second display grouping including at least two display panels forming a second display area. The visual display device further providing each of the display panels of the second display grouping is securable to a second common support device. The visual display device further providing at least one surface of the second common support device continuously forming a portion of the second display area. The visual display device further providing a structure connecting the first common support device and the second common support device. The visual display device further providing the at least two display panels of the first display grouping and the at least two display panels of the second display grouping are moveable in the same manner. Each of the first common support device and the second common support device is supported in a suspended disposition from a ceiling via either an arrangement in which one or both of the first common support device and the second common support device is connected to a direct suspended support member that is connected to the ceiling or an arrangement in which one or both of the first common support device and the second common support device is connected to a suspension framework and the suspension framework is connected to the ceiling via a direct suspended support member that is connected to the ceiling.

An advantage of the present disclosure is that the visual display device provides an authentic three dimensional visual experience, due to movement of display panels relative to one another.

Another advantage of the present disclosure is that the visual display device provides coordinated lighting effects in combination with the movement of display panels, providing a pleasing visual experience.

Yet another advantage of the present disclosure is that the visual display may be used in multiple media or surrounding environments, including one or more of air, water, fog and sound in combination with coordinated lighting effects to provide a pleasing audio/visual experience.

Yet another advantage of the present disclosure is that the structures for supporting the visual display can be configured to be substantially invisible.

Further aspects of the method and system are disclosed herein. The features as discussed above, as well as other features and advantages of the present disclosure will be appreciated and understood by those skilled in the art from the following detailed description and drawings.

### BRIEF DESCRIPTION OF THE DRAWINGS

FIG. 1 shows a perspective view of an exemplary embodiment of a visual display.

FIG. 2 shows a reverse perspective view of an exemplary embodiment of the visual display of FIG. 1.

FIG. 3 shows an enlarged perspective view of an exemplary embodiment of a visual display device.

FIG. 4 shows a reverse perspective view of an exemplary embodiment of the visual display device of FIG. 3.

FIG. 5 shows a perspective view of an exemplary embodiment of a support device.

FIG. 6 shows a reverse perspective view of an exemplary embodiment of the support device of FIG. 5.

FIG. 7 shows a perspective view of an exemplary embodiment of a display panel.

FIG. 8 shows a view taken along line 8-8 from FIG. 7 of an exemplary embodiment of a display panel.

FIG. 9 shows a partial cutaway view of an exemplary embodiment of a display panel.

FIG. 10 shows a view taken along line 10-10 from FIG. 1 of a visual display device.

FIG. 11 shows a view taken along line 11-11 from FIG. 10 of an exemplary embodiment of a support for a visual display device.

FIG. 12 shows an enlarged perspective view of the exemplary embodiment of a support of FIG. 11.

FIG. 13 shows a perspective view of an exemplary embodiment of a support member for a visual display.

FIG. 14 shows a front view of exemplary embodiment of a visual display.

FIG. 15 shows a side view of the exemplary embodiment of the visual display of FIG. 14.

FIG. 16 shows a view taken along line 16-16 from FIG. 14 of an exemplary embodiment of a visual display.

FIG. 17 shows a front view of the exemplary embodiment of a visual display.

FIG. 18 shows a side view of the exemplary embodiment of a visual display.

FIG. 19 shows an upper perspective view of an exemplary embodiment of a visual display.

FIG. 20 shows an upper perspective view of an exemplary embodiment of a visual display.

Wherever possible, the same reference numbers will be used throughout the drawings to represent the same parts.

### DESCRIPTION OF THE DISCLOSURE

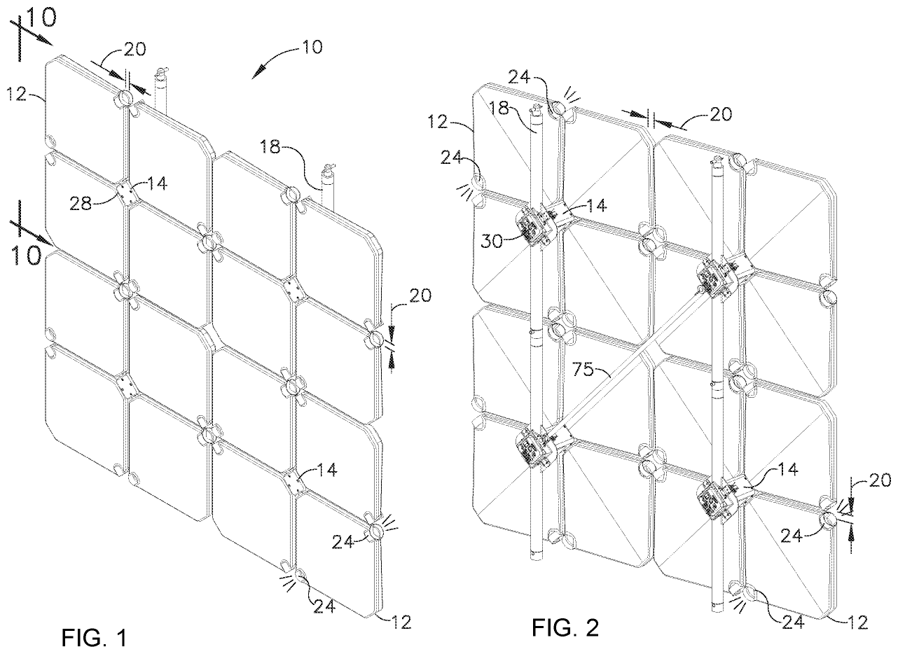

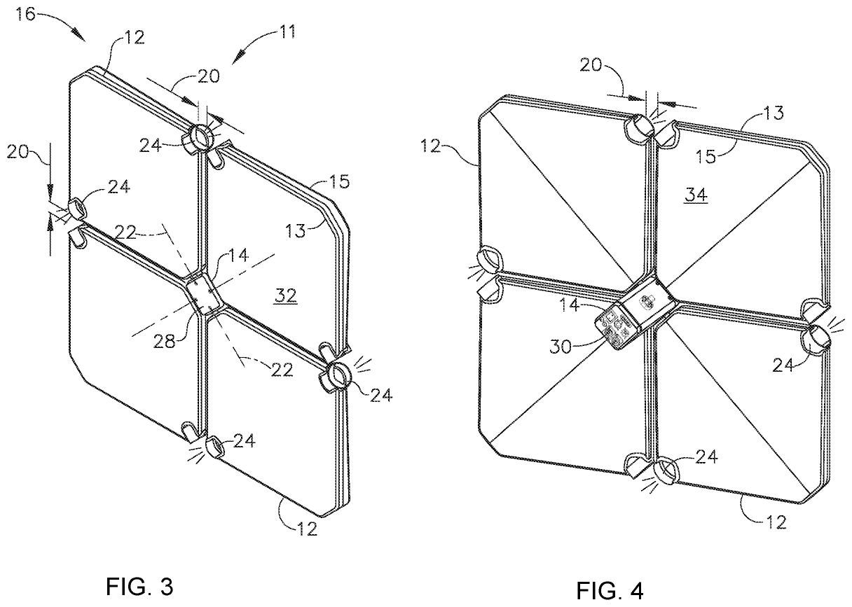

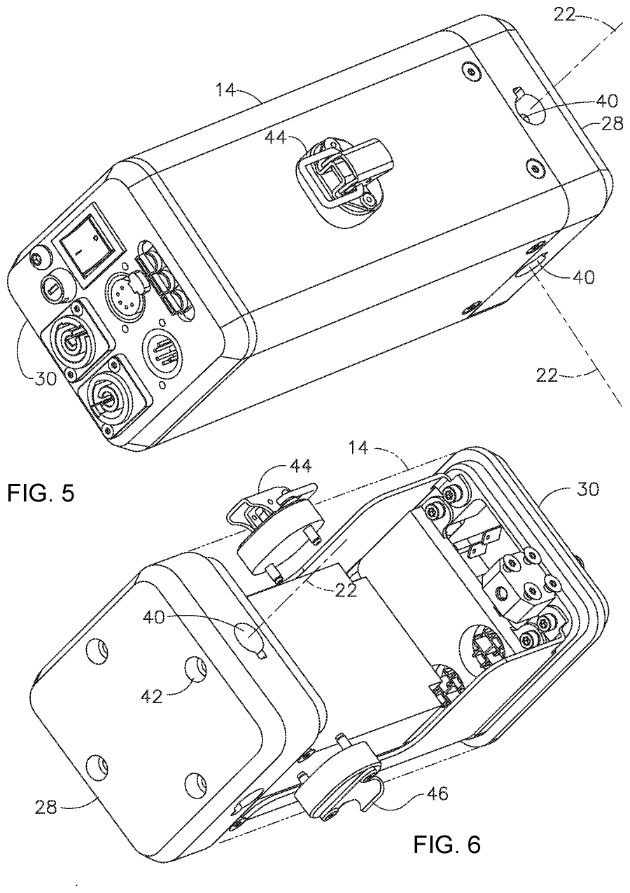

FIGS. 1 and 2 show opposed or reversed perspective views of a visual display 10 supported by structure 18. As further shown in FIGS. 3 and 4, visual display device 11 includes a plurality of display panels 12 secured to a common support device 14. As will be discussed in further detail below, in addition to being secured to the common support device 14, the plurality of display panels 12 are also independently movable relative to a corresponding panel axis 22 (e.g., FIGS. 3 and 5) of support device 14. The independent movement of display panels 12, including relative movement between adjacent display panels 12 of visual display device 11 can, by itself, form an integral part of a public performance. As will also be discussed in further detail below, such relative movement between display panels 12 either alone or in combination with specially configured visual effects, including illumination such as from illumination opening(s) 24 of one or more of display panels 12, other illumination effects associated with the surfaces of the display panels 12, external lighting sources, their combination, as well as interaction with a medium or surrounding environment associated with the visual display can provide an intriguing, highly entertaining visual experience associated with a performance.

In one embodiment, the visual display can be substantially vertical. In one embodiment, at least a portion of the visual display can be non-vertical. When a non-vertical portion of a visual display is at least partially overhead or at least partially vertically above an observer or vantage point, for purposes herein, the non-vertical portion of the visual display can be considered a ceiling relative to the observer or vantage point, with a plurality of display panels or ceiling display panels forming the non-vertical portion of the display area. The term “ceiling” is intended to not only include an overhead interior surface of an enclosure, but to also include a non-vertical portion of a visual display that is positioned at least partially overhead or at least partially vertically above an otherwise open or partially open or non-enclosed space. In other words, for purposes herein, the term “panel(s),” “display panel(s),” “ceiling panel(s),” “ceiling display panel(s),” and the like may be used to form a ceiling or ceiling portion of a visual display.

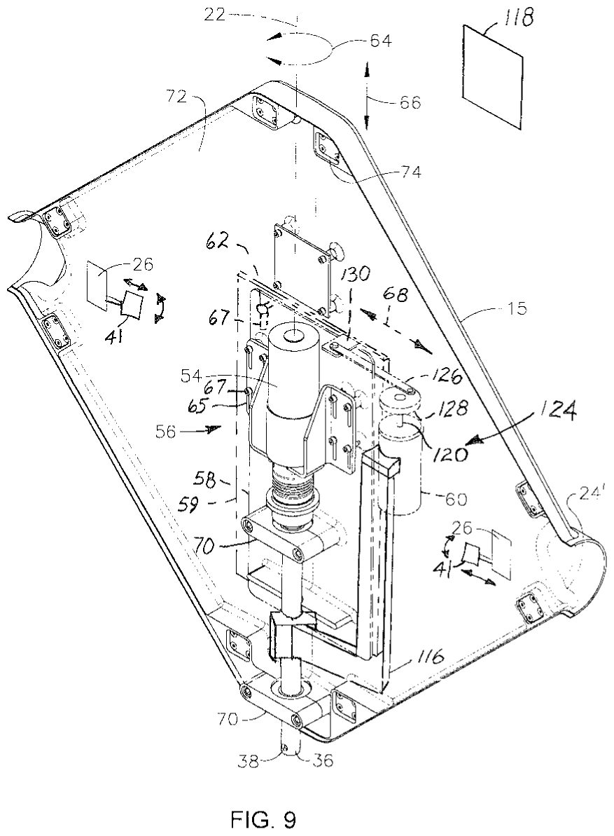

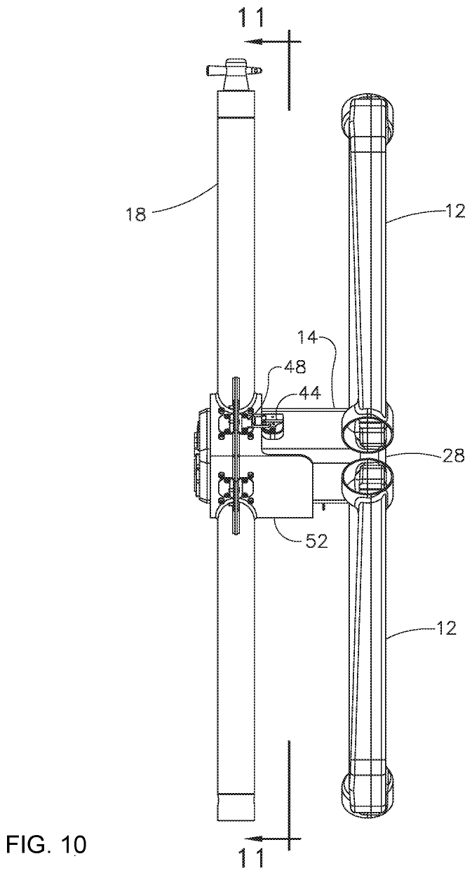

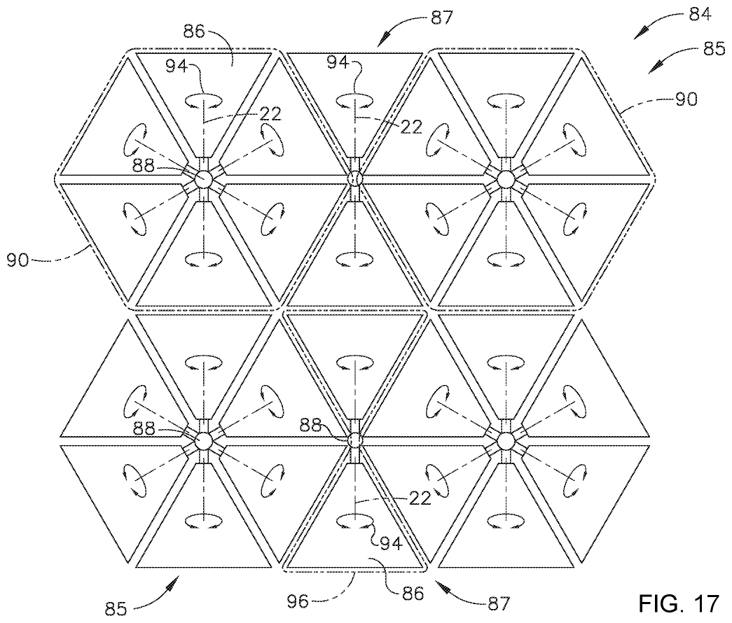

As further shown in FIGS. 3 and 4, an exemplary grouping or plurality of display panels 12, such as four display panels associated with a common support device 14 is now discussed. In one embodiment, such as shown in FIG. 17, a visual display 84 can include visual device(s) 85 containing more than four display panels 86, such as a plurality 90 of display panels that can be associated with a common support device 88. As further shown in FIG. 17, visual display 84 can include visual display device(s) 87 containing less than four display panels, such as a plurality 96 of display panels 86 which can be associated with common support device 88. As further shown in FIG. 17, a visual display, such as visual display 84 can contain a combination of different numbers of display panels that can be associated with a corresponding common support device. As yet further shown in FIGS. 3 and 4, display panels 12 include a pair of opposed illumination openings 24 for selectively providing illumination exterior of the display panels 12 by an illumination source 26 (FIG. 9) positioned inside or interior of the display panels 12. In one embodiment, at least one illumination source is movable relative to the display panel, such as by moving device 41 (FIG. 9).

It is to be understood that an illumination source can include one or more light emitting diodes (LEDs). In another embodiment, the illumination sources may include but are not limited to other light sources, for example organic light emitting diodes (OLEDs), incandescent bulbs, fluorescent bulbs, polymer light emitting diodes, electroluminescent lights, other suitable illuminating or light emitting sources. Such illumination sources can include different colors and intensities. In one embodiment, the illumination sources can change colors and intensities by themselves or in combination with movement of the display panels. In one embodiment, the exterior illumination sources are movable. In one embodiment, the display panels can include zero illumination openings. In another embodiment, the display panels can include one illumination opening. In yet another embodiment, the display panels can include more than two illumination openings. In one embodiment, the illumination openings may be positioned anywhere on the display panels, i.e., are not limited to corners or edges of the display panels. In one embodiment, the illumination opening(s) can be sized differently relative to one another. In one embodiment, the illumination opening(s) of display panels can be configured differently from each other.

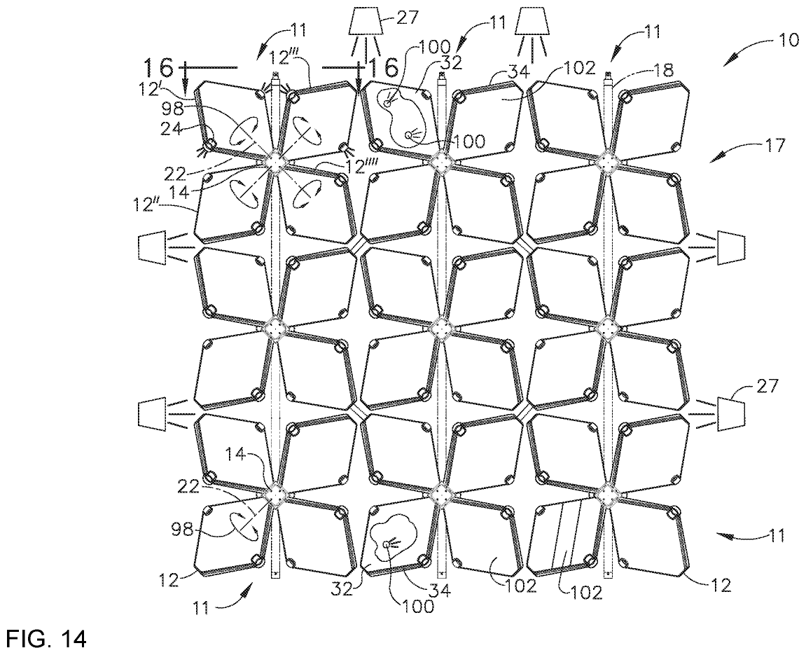

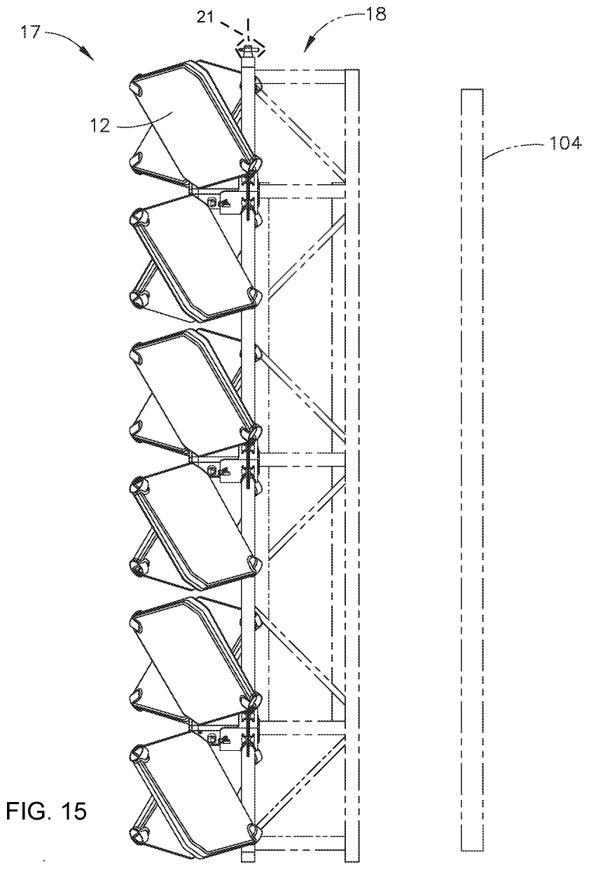

As further shown in FIGS. 3 and 4, in an assembled condition, an end 28 of support device 14 is positioned in close proximity or proximal to display panels 12, with end 30 positioned distally from display panels 12 forming a display area. As further shown collectively in FIGS. 3 and 4, display panels 12 of visual display device 11 are positionable in a first position 16, in which, for example, adjacent display panels 12 are separated by a spacing 20, such that display panels 12 provide an appearance of a substantially continuous surface relative to an adjacent display panel 12. As shown, the surface of end 28 continuously forms a portion of the display area with display panels in first position 16, or second position 17 (FIG. 14) or any transition between positions 16 and 17. In one embodiment, the spacing between adjacent display panels corresponding to a common support device can be different, and in another embodiment, the spacing between groupings of display panels corresponding to different support devices, such as for a visual display can be different. In one embodiment, the substantially continuous surface is substantially planar, while in other embodiments, at least one of the surfaces of the display panels 12 can be non-planar. In one embodiment, display panels 12 are substantially similar in size, shape and texture (e.g., visual behavior associated with the exterior surface of display panels) while in another embodiment, one or more display panels 12 may be shaped, sized and/or textured differently, according to the visual effect desired.

It is to be understood that movement 94 of display panels 86 relative to panel axis 22 in FIG. 17 corresponds to movement of one or more degrees of freedom relative to panel axis 22, including but not limited to rotational movement about panel axis 22, axial movement parallel to panel axis 22 as well as a pivoting movement relative to panel axis 22 as will be discussed in additional detail in another embodiment, in a similar manner as shown in FIG. 9.

It is to be understood that the term “a plurality of display panels” not only refers to display panels secured to a common support device, but includes a collection or compilation of display panels and their corresponding common support devices, such as shown in the FIGS. 1 and 14.

As shown collectively in FIGS. 3-12, display panel 12 includes a pair of opposed display panel portions 13, 15 having corresponding exterior surfaces 32, 34. As further shown collectively in FIGS. 8-9, display panel portion 15 includes a bend 19 formed therein, resulting in a faceted exterior surface 34, as well as an illumination opening portion 24′ associated with one or more illumination sources 26 as previously discussed. Display panel portion 15 further includes a motor 54 secured inside of display panel 12 by motor mounting hardware 56, including but not limited to a bracket, bearing holder, and fasteners. As further shown in FIG. 9, motor 54 is secured to a shaft 36 including a panel axis 22 and having an aperture 38 positioned near an end of shaft 36 opposite motor 54. Shaft 36 of motor 54 is configured to be received in an opening 40 of support device 14 in close proximity to end 28 of support device 14. An aperture 42, such as a threaded aperture is configured to receive a fastener (not shown) such as a threaded fastener that extends through a corresponding opening 40 of support device 14 and an aligned aperture 38 of shaft 36 that has been inserted inside of opening 40. As further shown in FIGS. 5 and 6, openings 40 have a panel axis 22.

Upon assembly of shaft 36 to support device 14, shaft 36 and opening 40 are aligned with panel axis 22. As shown in FIG. 5, opening 40 includes a slot or keyway that provides an insertion orientation of shaft 36 relative to opening 40. That is, shaft 36 may include a protruding portion (not shown) such as a pin or a machined protruding feature formed in shaft 36 such that the protruding portion of shaft 36 must be aligned with the slot or keyway of opening 40 to permit insertion of shaft 36 in opening 40. Such alignment features ensure proper orientation of the display panels relative to the support device. Further, by virtue of assembly of shaft 36 inside of opening 40, there is essentially no relative movement of shaft 36 relative to support device 14. In other words, if motor 54 urges shaft 36 into rotational movement 64 about panel axis 22 in one direction relative to display device 12, by virtue of the nonmoving connection between shaft 36 relative to support device 14 (with support device 14 remaining in a fixed reference position), the resulting movement relative to support device 14 is rotational movement of display panel 12 about panel axis 22 in an opposite direction. As a result of the nonmoving relationship between shaft 36 and opening 40 of support device 14, as shown in FIG. 14, each support device 14 includes four nonmovable shafts 36 from corresponding display panels 12, which display panels 12 collectively forming a portion of visual display 10

As further shown in FIG. 9, degrees of freedom of movement of panel portion 15 of display panel 12 (FIG. 4) relative to support device 14 (FIG. 4) are now additionally discussed. For example, display panel 12, which includes panel portion 15, is movable in each of directions 66 along axis 22, as well as independent rotational movement 64 about axis 22. A plane 118 is coincident with or parallel to axis 22. Such movement occurs as a result of mounting hardware 56 which affixes motor 54 to a panel 59 that is further affixed to an inside base surface 72 of display panel portion 15. A panel 58 positioned between mounting hardware 56 and panel 59 is slidably movable relative to panel 59, such as by at least one stand-off fastener 62 secured to panel 59, which stand-off fastener 62 extending through a cooperating slot 63 formed in panel 59. As shown, stand-off fasteners 67 secured to panel 59 and extending through cooperating slots 65 formed in mounting hardware 56 also permit panel 58 to slidably move relative to panel 59. That is, in response to motor 54 being actuated such that motor 54 is urged into movement in one direction 66 along axis 22 relative to the opposite end of shaft 36, mounting hardware 56 likewise urges panel 59 into movement in the same direction 66 along axis 22, the resulting movement relative to support device (FIG. 4) is movement of panel portion 15 in the same direction 66 along axis 22. Similarly, in response to motor 54 being actuated such that motor 54 is urged into rotational movement 64 in one direction about axis 22 relative to shaft 36 (with shaft 36 being nonmovingly connected to support device 14, as previously discussed) stationary mounting hardware 56 likewise urges panel 59 into rotational movement 64 in the same direction, resulting in panel portion 15 also being urged into rotational movement 64 about axis 22 in the same direction.

As further shown in FIG. 9, an assembly 124 provides an optional additional degree of freedom of movement of panel portion 15 of display panel 12 relative to support device 14 is now discussed. As shown, assembly 124 includes an arm 116 having two generally perpendicular arm segments. Arm 116 is rotatably secured to shaft 36 at one end of the arm and nonmovingly secured to a motor 60 at the other end of the arm. Motor 60 rotatably drives a take-off shaft 120 that is connected to a linkage element 126. In one embodiment, an end member 128, such as a disk is secured to an end of take-off shaft 120 opposite motor 60, with one end of linkage element 126 being rotatably secured to end member 128, the other end of linkage element 126 being rotatably connected to a connector 130 that is affixed to panel 59. In one embodiment, shaft 128 may have a diameter of sufficient size such that an off-centered rotatably secured connection with the linkage element may not require an end member. As a result, assembly 124 includes at least, arm 116, motor 60, take-off shaft 128, (optionally) end member 128, linkage element 126 and connector 130. As a result of assembly 124, in response to motor 60 rotatably driving take-off shaft 120, linkage element 126 is moved along a reciprocation path resulting in panel 59, and in effect, panel portion 15 of display panel 12 to be moved, such as oscillating pivoting movements 68 in opposite directions, which movements 68 being parallel to plane 118 corresponding to display panel 12. In one embodiment, movements 68 are coincident with plane 118. In one embodiment, oscillating pivoting movements 68 occur about bearing holder 70. In one embodiment, oscillating pivoting movements 68 occur about a junction between motor 54 and shaft 36. In one embodiment, motor 60 urges panel 59 to provide oscillating pivoting movements 68 parallel to plane 118 (or coincident with plane 118) using a rack and pinion arrangement, or other suitable apparatus or construction. As a result, in response to selective enablement, actuation or the like of one or more of motors 54, 60, display panel 12 is movable in up to three degrees of freedom relative to panel axis 22 or plane 118 that is parallel to or coincident with axis 22. In one embodiment, display panel 12 is simultaneously movable in more than one degree of freedom. A controller (not shown) for controlling movement of the display panels 12 of the visual display may be contained inside of one or more of the respective support device(s) 14 or exterior of and remotely positioned relative to the support device(s) 14. In one embodiment, more than three degrees of freedom can exist between the support device and the display panel.

It is to be understood that plane 118 can have different orientations, depending upon the amount of rotational movement 64 about axis 22. By virtue of arm 116 being rotatably secured to shaft 36, oscillating pivoting movements 68 occurring during operation of motor 60 are maintained parallel to plane 118.

It is to be understood that each of the motors controlling movement of the display panels relative to the corresponding support device can be selectably or independently actuated relative to one another to achieve the desired visual effect as well as preventing the display panels from colliding with one another during operation, such as when display panels are urged into sufficient axial movement about and/or pivoting movement relative to corresponding axes or support devices.

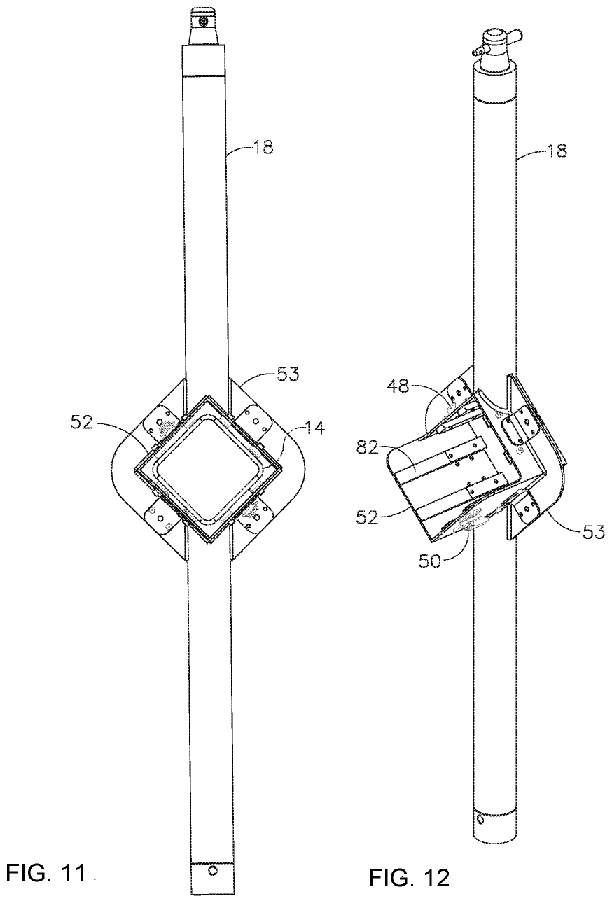

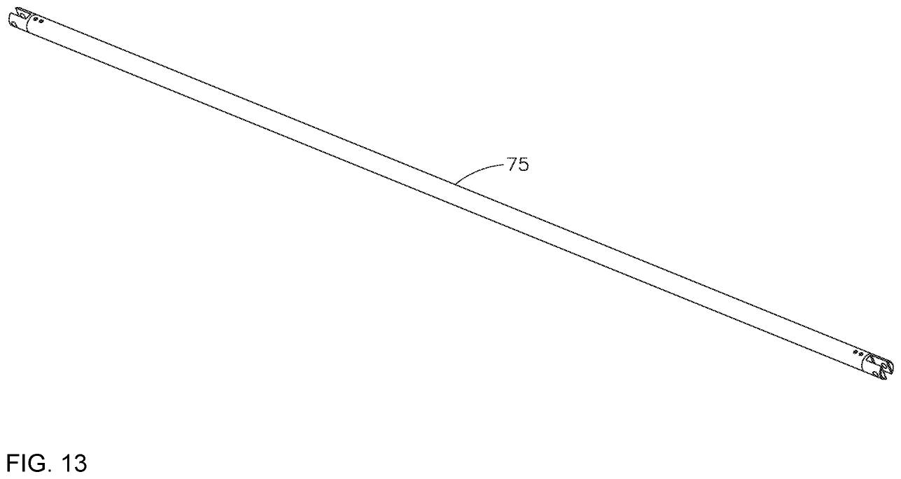

As further collectively shown in FIGS. 2, 5, 6, 10-13 and 15, structure 18 includes a partial enclosure portion or partial enclosure 52 (FIG. 12) configured to receive and secure support device 14 without requiring hand tools. That is, as shown collectively in FIGS. 11 and 12, the body of support device 14 is configured and sized to be slidably received by partial enclosure 52. To simplify installation of support device 14 in partial enclosure 52, guide features 82 (FIG. 12) are formed in partial enclosure 52. Upon installation of support device 14 in partial enclosure 52, as shown in FIG. 10, a latch portion 44 of support device 14 engages a corresponding mating latch portion 48 of partial enclosure 52. Similarly, a latch portion 46 (FIG. 6) opposite latch portion 44 of support device 14 engages a corresponding mating latch portion 50 (FIG. 12). As a result of manually engaging/disengaging the corresponding mating latch portions of support device 14 and partial enclosure 52 of support structure 18, support device 14 is easily manually installed/removed from support structure 18.

For purposes of the present disclosure, as further clarified above in the context of engaging/disengaging fasteners (mating latch portions) and otherwise installing/removing the support device relative to the supporting structure, the term “without requiring hand tools” and the term “manually” or variations thereof are used interchangeably.

As further shown in FIGS. 2 and 11-13, a reinforcing member 75 is selectively securable, such as by a quick-release fastener, such as a ball-lock pin (not shown) to a corresponding reinforcing flange 53 associated with partial enclosure 52 of structure 18. As further shown in FIG. 2, reinforcing members 75 (one reinforcing member 75 shown in FIG. 2) may extend between reinforcing flanges 53 associated with partial enclosures 52, which partial enclosures 52 secure and provide structural support for support devices 14. FIG. 14 (resembling a reverse view of FIG. 2) partially shows a plurality of reinforcing members 75 positioned in a diamond shaped arrangement to provide support and rigidity to support structure 18.

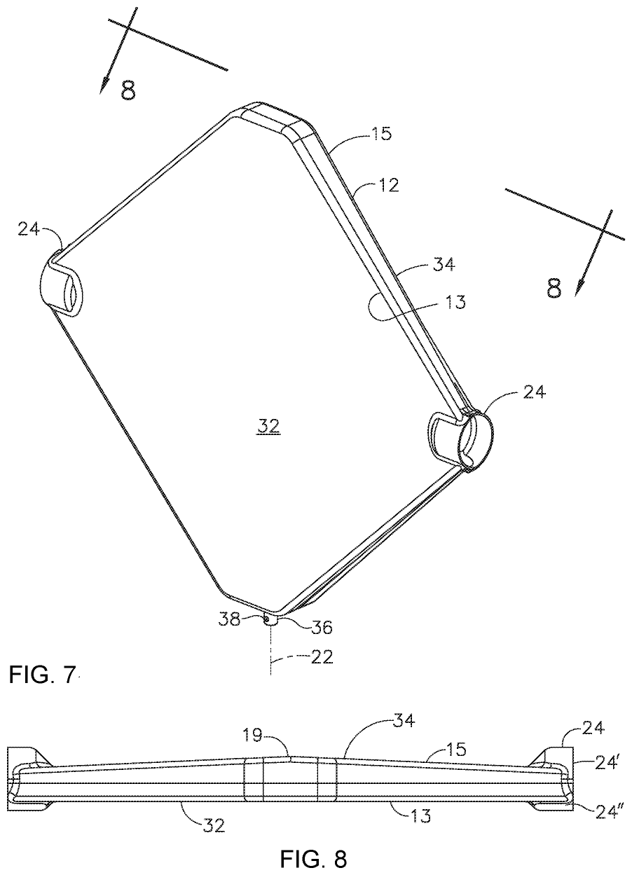

As further shown in FIG. 9, display panel portion 15 includes an illumination opening portion 24′ having one or more illumination sources 26, such as previously discussed. Display panel portion 15 can be secured to a corresponding display panel portion 13 using non-mechanical fasteners 74, such as magnets which additionally help align and guide the corresponding display panel portions 13, 15 together. In other words, non-mechanical fasteners 74 provide mating features between display panel portions 13, 15 that are reusable, selectably separable and self-aligning. As further shown in FIGS. 7 and 8, display panel portions 13, 15 include corresponding exterior surfaces 32, 34, in which surface 32 is substantially planar and surface 34 is faceted. In one embodiment, the exterior surfaces can both be substantially planar. In another embodiment, the exterior surfaces can both be nonplanar. In another embodiment, the opposed surfaces and/or portions of the exterior surfaces of the display panels can be shaped or behave in a visually different manner relative to the same display panel, as well as between different display panels. That is, portions of exterior surfaces, as well as entire opposed exterior surfaces of the same or different display panels can have features that involve different visual effects, such as opacity, translucence, reflection, diffusion, transparency, or a combination thereof. Diffusion is intended to include prismatic diffusion of light into the visible spectrum, as required to achieve a desirable visual effect.

As shown collectively in FIGS. 14 and 15, visual display 10 includes a plurality of display panels 12. However, for purposes of showing an alternate embodiment (taken along line 16-16 of FIG. 14), a plurality or grouping of display panels are identified as to 12′, 12″, 12′″ and 12″″, but are otherwise identified as display panels 12 in FIGS. 14 and 15. In addition, any combination of one or more degrees of freedom of selective movement of display panels 12, (and 12′, 12″, 12′″, 12″″) relative to or about panel axis 22 of support device 14, such as previously discussed, is generically identified as selective movement 98. As further shown collectively in FIGS. 14 and 15, the display panels 12 are collectively arranged to resemble at least a partially discontinuous surface or second position 17 relative to at least an adjacent display panel in which each of the display panels 12 are rotated to a predetermined position about panel axis 22 relative to support device 14. As previously discussed, it is to be understood that the display panels can be moved independently relative to one another, in which movement of one display panel can selectively differ from movement of any other display panel, if desired.

The display panels 12 can be illuminated by zero illumination source(s) or more than one and/or a combination of exemplary illumination source(s) not intending to be limiting, such as emanating from inside of the display panels 12 through illumination opening(s) 24, illumination source(s) 27 exterior of the display panels 12 and positionable at any locations relative to the display panels 12, illumination source(s) 100 emanating through the exterior surface(s) 32, 34 from interior of the display panels 12, and from illumination source(s) 102 which comprise a portion of the exterior surfaces, if not one or both entire external surfaces of one or more of the panels being, for example, a low or high resolution LED panel or configured to display lighting and/or video presentations. In one embodiment, illumination source(s) 100 can emanate through openings formed in at least one of exterior surfaces 32, 34 other than illumination openings 24 or through non-opaque display panel portions 13, 15. In another embodiment, illumination source (s) 100 can be movable inside of display panels 12, such as by motors or other suitable movement device (not shown). In one embodiment, a large number of closely spaced LEDs (not shown) of illumination source(s) 102 may be included thereby creating the effect that LEDs are of high resolution. In another embodiment, the panels of illumination source(s) 102 may additionally or alternatively include Organic Light Emitting Diodes (“OLEDs”) or other light sources capable of displaying images, video, or other visual displays. The panels of illumination source(s) 102 can be semi-translucent, semi-transparent, transparent, translucent, semi-opaque, opaque, or combinations thereof. In addition, LEDs of illumination source(s) 102 may be connected by electrical and/or control wires or other connectors or wireless connections. In one embodiment, panels of illumination source(s) 102 may permit high resolution including a large number of colored, closely spaced pixels permitting a clear, high resolution image, series of images, and/or video. In one embodiment, visual display 10 may be positioned in front of an LED display 104, with display panels 12 of visual display 10 selectively revealing portions of LED display 104, as desired.

In one embodiment, one or more of the illumination sources of the present disclosure can selectively change color and/or intensity, for providing desired visual effects.

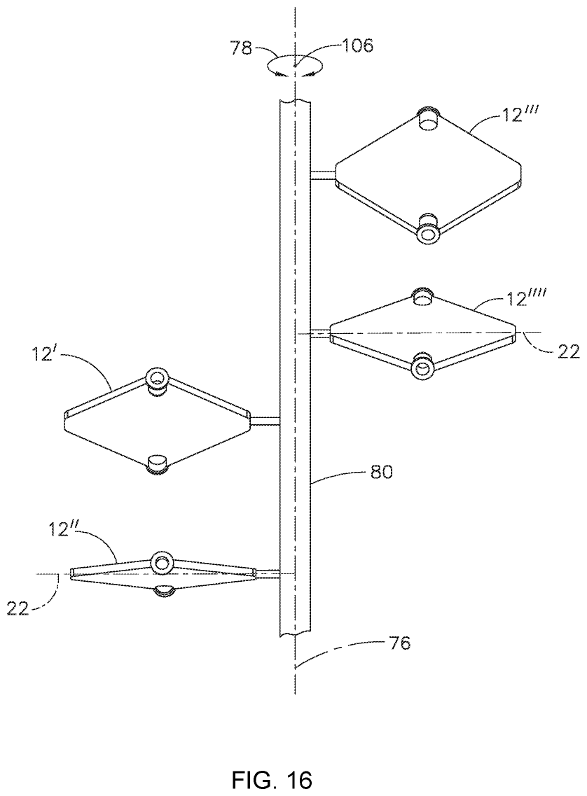

As shown in FIG. 16, which is a view taken along line 16-16 of FIG. 14, is an alternate embodiment of the visual display. FIG. 16 shows a support device 80 having an axis 76 for collectively securing display panels 12′, 12″, 12′″ and 12″″ about their respective panel axes 22 along axis 76. That is, as shown in FIG. 16, display panels 12′, 12″, 12′″ and 12″″ are separated by a spacing relative to one another along axis 76, i.e., the supporting panel axes 22 are not coplanar. In one embodiment, one or more of the supporting panel axes 22 can be coplanar. As further shown in FIG. 16, support device 80 can move relative to axis 76, such as a pivoting movement 78 about a reference point 106. In another embodiment, support device 80 can generate a rotational movement about axis 76. In one embodiment, corresponding panels axes 22 of one or more of display panels 12′, 12″, 12′″ and 12″″ can move relative to axis 76 of support device 80, including but not limited to axial movement along axis 76, rotational movement about axis 76, as well as a pivoting movement relative to axis 76, in addition to the multiple degrees of freedom of movement of one or more of display panels 12′, 12″, 12′″ and 12″″ relative to panel axis 22, such as previously discussed.

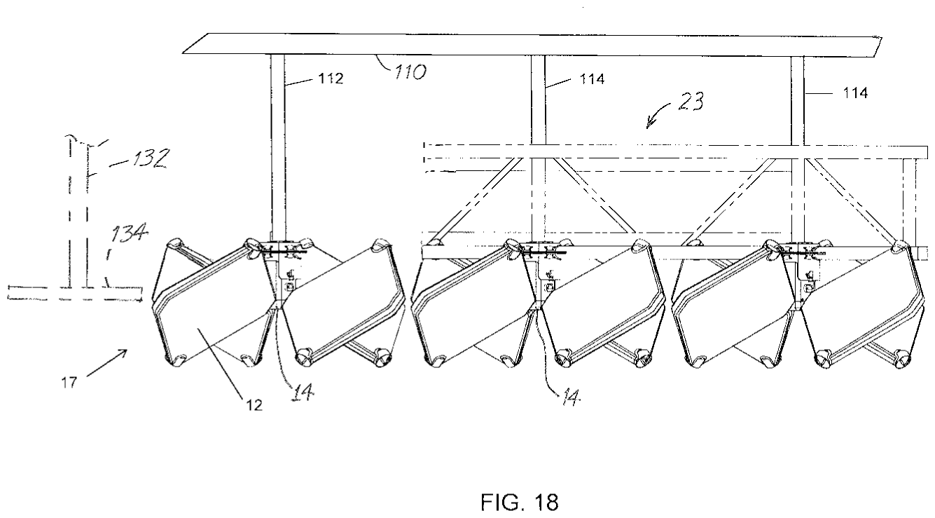

FIG. 18 shows an alternate embodiment of the visual display, in which the visual display is supported in a suspended disposition from a ceiling 110. As further shown in FIG. 18, the visual display supported in a suspended disposition in at least one or more arrangements. For example, as shown, support device 14 is supported in an arrangement in which support device 14 is connected to a direct suspended support member 112 that is connected to ceiling 110. Alternately, support device 14 is supported in a suspended disposition in an arrangement in which support device 14 is connected to a frame or structure or frame structure or suspension framework 23 and the suspension framework 23 is connected to ceiling 110 via one or more direct suspended support members 114 connected to ceiling 110. In one embodiment, support devices 14 of the visual display may be supported by a combination of direct suspended support member 112 and suspension framework 23 and direct suspended support member 114. As previously discussed, it is to be understood that the display panels can be moved independently relative to one another, in which movement of one display panel can selectively differ from movement of any other display panel, if desired. Such movement includes operating arrangements in which one or more display panels may selectably simultaneously move, or simultaneously not move, at least partially simultaneously move, or in other words, any combination of movement/non-movement relative to one another. The arrangement of support device 14 can resemble the arrangement of FIG. 14 in which at least two axes for moving adjacent panels are perpendicular to each other, although support device devices such as support device 88 (FIG. 17) include at least two axes for moving adjacent panels that are not perpendicular to each other. In one embodiment, a direct suspended support member 132 connected to ceiling 110 may be connected to and support a fixed or fixed view display panel 134 that does not move relative to ceiling 110. In one embodiment, direct suspended support member 132 may be connected to ceiling 110 and may be connected to and support suspension framework 23 that is connected to and supports fixed view display panel 134 that does not move relative to ceiling 110.

FIG. 17 shows an alternate arrangement of a visual display 84, in which triangular shaped display panels 86 move relative to corresponding panel axes 22 of corresponding support devices 88. As further shown in FIG. 17, visual display 84 includes a combination of pluralities or groupings of display panels 86. For example, a grouping or plurality 90 of display panels 86 defines a collective hexagonal periphery along the ends of display panels 86 secured about a corresponding support device 88. Interspersed between horizontally positioned adjacent groupings or pluralities 90 of display panels 86 are groupings or pluralities 96 of display panels 86 defining a collective “bow tie” peripheral outline about corresponding support devices 88. That is, by interspersing pluralities 90 of display panels 86 and pluralities 96 of display panels 86, a continuous arrangement of display panels 86 is achieved. It is to be understood that the present disclosure includes the virtually endless possible arrangements of pluralities of display panels.

It is to be understood that display panels, such as display panels 86 can include more than one pair of opposed surfaces, such as three (defining a triangular pyramid, for example) or more surfaces, if desired, so long as relative movement of the display panels can be achieved without colliding with one another. It is also to be understood that the display panels are not required to be of the same shape and/or size, can have different numbers of opposed surfaces, textures, and visual features as desired for particular applications.

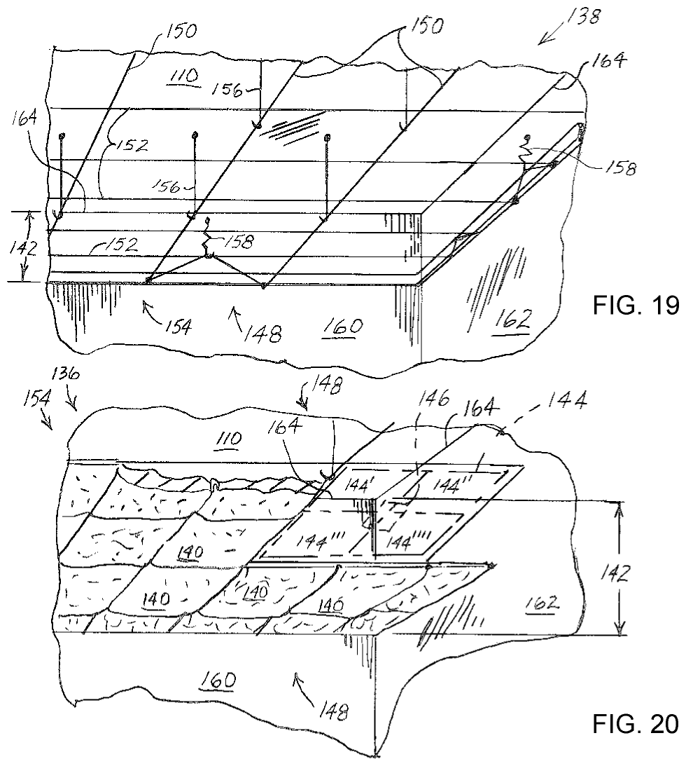

FIGS. 19-20 show an exemplary embodiment of a visual display comprising an assembly 136 providing selective visual displays. As shown, assembly 136 includes a suspension framework 138 having a plurality of support members 150 extending in a first direction and a plurality of support members 152 extending in a second direction, forming a grid structure 154. In one embodiment, support members 150, 152 are cables, including a tensioning device 158 for maintaining cable tension to prevent drooping. As shown, suspension framework 138 further includes a plurality of direct suspended support members 156, maintaining support members 150, 152 at a predetermined stand-off spacing 142 from a reference surface or ceiling 110, the upper extent of the predetermined stand-off spacing 142 corresponding to a corner 164 between ceiling 110 and side walls 160, 162. In one embodiment, stand-off spacing 142 may vary in length for such reasons including, but not limited to the ceiling being curved, the support members being curved relative to the ceiling, or support members being curved or offset at an amount or a rate different from the ceiling, providing a three-dimensional effect formed by display panels supported by the suspension framework as a result of one or more display panels being spaced further from the ceiling than other display panels, and other reasons. Assembly 136 includes additional features, such as disclosed in U.S. Pat. No. 3,418,766 titled SUSPENDED CEILING SYSTEM, which is herein incorporated by reference in its entirety. It is appreciated such a suspended ceiling system may be configured in any number of arrangements. For example, in one embodiment, the suspension framework may be comprised at least partially of rigid support members, such as similar to frame structure 23 (FIG. 18).

As shown in FIG. 20, a plurality of fixed panels or fixed display panels or fixed view panels 140 are supported, such as being supported along their peripheries by suspension framework 138 at predetermined stand-off spacing 142 from ceiling 110. In one embodiment, fixed view panels 140 are ceiling tiles. As further shown, a plurality of movable or variable tilt panels 144 or 144′, 144″, 144′″, 144″″, similar to display panels 12′, 12″, 12′″, 12″″ (FIG. 14), are supported by suspension framework 138 at predetermined stand-off spacing 142 from ceiling 110. Panels 140, 144 may have any number of arrangements, providing selective visual displays, depending upon application and/or the imagination of the installer and desired visual effects to be provided by the panels. As previously discussed, portions of suspension framework 138, which may correspond to one or more fixed view panels 140 may have a predetermined stand-off spacing that is different from one or more of other predetermined stand-off spacings corresponding to one or more variable tilt panels 144.

As previously discussed, as a result of the nonmoving relationship between shaft 36 (FIG. 6) extending exterior of a display panel portion 15 (FIG. 9) of a display panel and a corresponding opening 40 (FIG. 6) of support device 14, as shown in FIG. 14, each support device 14 includes four nonmovable shafts 36 from corresponding display panels 12, which display panels 12 collectively forming a portion of visual display 10. Similarly, as shown in FIGS. 19-20, support device 146 is supported within a display area 148 by suspension framework 138, with variable tilt panels 144′, 144″, for example, in which variable tilt panel 144′ is independently movable relative to a corresponding nonmovable axis 22 (FIG. 3) associated with support device 14 (similar to support device 146), and variable tilt panel 144″ being independently movable relative to a corresponding axis 22 associated with support device 14 (similar to support device 146). Similarly as shown, in FIG. 3, the nonmovable axes 22 are nonparallel to each other, and variable tilt panel 144′ and variable tilt panel 144″ are capable of simultaneous movement. Similar to the arrangement previously discussed and shown in FIG. 18, as shown in FIGS. 19-20 where possible, support device 146 is supported in a suspended disposition from ceiling 110 via an arrangement or assembly 136 in which support device 146 is connected to suspension framework 138 that is connected directly to ceiling 110. In one embodiment, similar to FIG. 18, support device 146 may be supported in an arrangement in which support device 146 is connected to a suspension framework 138 and the suspension framework 138 is connected to the ceiling 110 via a direct suspended support member 23 (FIG. 18) that is connected to ceiling 110. In one embodiment, the support device is supported within the display area delimited by the suspension framework.

In one embodiment, the support structure 18 (FIGS. 14 and 15) can be configured to be substantially invisible, which can be beneficial if the visual display is utilized to selectably mask objects/activities positioned behind the visual display, such as an LED display. While different techniques may be employed to render support structure 18 substantially invisible, including fabricating support structure from materials that are transparent, semi-transparent or the like, in one embodiment, the support structure could at least partially comprise or primarily comprise cables 21 (FIG. 15), such as aircraft grade steel cables. In other embodiments, support structure 18 can be coated with non-reflective materials and/or of colors that could blend in with the background environment associated with the performance. If the visual display is utilized to selectably mask objects/activities positioned behind the visual display, such as an LED display, the display panels could be rotated 90 degrees relative to a first position 16 as shown in FIG. 1. For example, as shown collectively in FIGS. 14 and 15, the display panels in the second position 17 are each rotated approximately 45 degrees relative to first position 16 as shown in FIG. 1. In another embodiment, the panels can be configured to be opaque when a first exterior surface is facing an audience during a performance, while also being configured to be transparent when an opposed second exterior surface is facing the audience during the performance. In such an arrangement, the display panel surfaces would be oriented at zero degrees or 180 degrees relative to each other, depending upon the desired visual effect to be provided. One exemplary application could be for the visual display to be positioned in front of a performance stage, such as a performance stage having multiple portions. In such an arrangement, a portion of the visual display could permit selective viewing of a first portion of the performance stage while concealing a second portion of the performance stage. This arrangement could permit preparations for a subsequent scene or aspect of a performance associated with the second portion of the performance stage, while simultaneously permitting the performance occurring on the first portion of the performance stage to be viewed. In this arrangement, the length of intermissions or “down times” could be reduced or possibly eliminated.

It is to be understood that the visual display of the present disclosure can be utilized in applications involving one or more different media. For example the visual display can be used in water such as suspending at least a portion of the visual display in a pool in sufficiently close proximity to the surface of the pool such that movement of the display panels of the visual display, in combination with illumination arrangements as previously discussed, provides an intriguing visual display that includes the resulting manipulation of the texture of the surface of the water pool, including patterns and or designs formed by the display panels. In one embodiment, the visual display can include electroacoustic devices, such as audio speakers, positioned in or on any portion of the visual display components, including structure, which electroacoustic devices capable of producing audio or visual effects, such as ripples in the water or surrounding media. In another embodiment, the visual display can include bubble-making apparatus for providing visual effects. Similarly, the display panels may be used in combination with a falling water layer flowing over or behind the display panels, or arranged for use with smoke/fog, including but not limited to fog created by carbon dioxide sublimation alone or in combination with illumination arrangements as previously discussed. That is, by virtue of the visual effects desired as well as the environment or surrounding media, the display panel may be used in a multitude of orientations and illumination arrangements.

For example, in another application, the display panel may be used with one or more lasers/reflectors as part of a visual performance, including but not limited to patterns, text, and pictorial displays.

In another embodiment, the visual display, in and of itself, may not be directly visible by an audience viewing a performance, but nonetheless can contribute greatly to the visual performance. For example, a visual display can be positioned substantially horizontally, such as behind a raised curtain such that the visual display itself may not be directly viewable by an audience. However, the visual display could be utilized to interact with illumination arrangements either suspended or positioned along the floor or other position in the performance venue, to provide lighting for other objects and/or actors associated with the performance.

It is to be understood that the embodiments and features disclosed herewith may be utilized in any combination or media to provide intriguing, entertaining visual effects, and are contemplated by the present disclosure.

While the disclosure has been described with reference to a preferred embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A visual display device comprising:
a plurality of display panels forming a display area, each of the display panels is securable to a common support device and independently movable relative to a nonmovable axis associated with the common support device, the common support device nonmovably positioned within the display area, the display panels positionable in a first position, comprising a first display panel movable relative to a nonmovable first axis and a second display panel movable relative to a nonmovable second axis, the first axis and the second axis being nonparallel to each other, wherein the first display panel and the second display panel are capable of simultaneous movement;
wherein the common support device is supported in a suspended disposition from a ceiling via either an arrangement in which the common support device is connected to a direct suspended support member that is connected to the ceiling or an arrangement in which the common support device is connected to a suspension framework and the suspension framework is connected to the ceiling via a direct suspended support member that is connected to the ceiling.

2. The visual display device according to claim 2, wherein the first display panel and the second display panel are capable of non-simultaneous movement in which the first display panel is moved relative to the nonmovable first axis during a time that the second display panel is not moved relative to the nonmovable second axis.

3. The visual display device according to claim 3, wherein the first axis and the second axis are perpendicular to each other.

4. The visual display device according to claim 1, wherein the first nonmovable axis is comprised in a first plane and further comprising an assembly for selectively moving the first display panel parallel to the first plane.

5. The visual display device according to claim 5, wherein the assembly for selectively moving the first display panel parallel to the first plane includes a motor having a take-off shaft and a linkage element connected to the take-off shaft and the first panel, the motor drivingly rotating the take-off shaft to reciprocate the linkage element along a reciprocation path, whereupon the first panel is reciprocally moved in opposite directions parallel to the first plane via movement of the linkage element along the reciprocation path.

6. The visual display device of claim 1, wherein the first position of the display panels provides an appearance of a substantially continuous surface relative to an adjacent display panel.

7. The visual display device of claim 7, wherein the substantially continuous surface is substantially planar.

8. The visual display device of claim 1, wherein each of the display panels is independently rotatable relative to an axis associated with the common support device.

9. The visual display device of claim 1, wherein at least one of the display panels is independently pivotably movable relative to an axis associated with the common support device.

10. The visual display device of claim 1, wherein each axis radially extending outward from the common support device.

11. The visual display device of claim 1, wherein illumination is provided from at least one source external of the display panels.

12. The visual display device of claim 1, wherein at least a portion of an external surface of at least one display panel includes a first surface feature on the exterior surface providing a visual effect different than a visual effect provided by a second surface feature on the external surface of a remaining portion of the at least one display panel.

13. The visual display device of claim 13, wherein at least one of the first surface feature and the second surface feature involves opacity, translucence, reflection, diffusion, transparency, or a combination thereof.

14. The visual display device of claim 1, wherein at least one display panel having an illumination source providing illumination from interior of the display panel.

15. The visual display device of claim 14, wherein at least one illumination source is movable relative to the display panel.

16. The visual display device of claim 14, wherein at least a portion of one display panel is a high resolution panel.

17. An assembly for providing select visual displays, the assembly comprising:
a suspension framework;
a plurality of fixed view panels, each fixed view panel being supportable by the suspension framework at a predetermined stand-off spacing from a reference surface;
a plurality of variable tilt panels, each variable tilt panel being supportable by the suspension framework at a predetermined stand-off spacing from the reference surface; and
a common support device, the common support device being supported within a display area delimited by the suspension framework, a first one of the variable tilt panels being independently movable relative to a first nonmovable axis associated with the common support device, a second one of the variable tilt panels being independently movable relative to a second nonmovable axis associated with the common support device, and the first nonmovable axis and the second nonmovable axis being nonparallel to each other, wherein the first one of the variable tilt panels and the second one of the variable tilt panels are capable of simultaneous movement.

18. The assembly for providing select visual displays according to claim 17, wherein the reference surface is delimited by a ceiling and the common support device is supported in a suspended disposition from the ceiling via either an arrangement in which the common support device is connected to the suspension framework that is connected directly to the ceiling or an arrangement in which the common support device is connected to the suspension framework and the suspension framework is connected to the ceiling via a direct suspended support member that is connected to the ceiling.

19. The assembly for providing select visual displays according to claim 17 and further comprising a plurality of ceiling tiles and a grid structure for supporting the ceiling tiles, the common support device is configured to be suspended from the same grid structure.

20. A visual display device comprising:
a first display grouping comprising at least two display panels forming a first display area, each of the display panels of the first display grouping is securable to a first common support device, at least one surface of the first common support device continuously forming a portion of the first display area;
a second display grouping comprising at least two display panels forming a second display area, each of the display panels of the second display grouping is securable to a second common support device, at least one surface of the second common support device continuously forming a portion of the second display area; and
a structure connecting the first common support device and the second common support device;
wherein the at least two display panels of the first display grouping and the at least two display panels of the second display grouping are moveable in the same manner;
wherein each of the first common support device and the second common support device is supported in a suspended disposition from a ceiling via either an arrangement in which one or both of the first common support device and the second common support device is connected to a direct suspended support member that is connected to the ceiling or an arrangement in which one or both of the first common support device and the second common support device is connected to a suspension framework and the suspension framework is connected to the ceiling via a direct suspended support member that is connected to the ceiling.
